(19) United States
(12) Patent Application Publication
(10) Pub. No.: US 2002/0017049 A1
(43) Pub. Date: Feb. 14, 2002

(54) Multipurpose fishing net

(76) Inventors: Russell D. Millett, Waterford, ME (US); Brenda T. Millett, Waterford, ME (US)

Correspondence Address: Richard C. Ltiman, LITMAN LAW OFFICES, LTD., P.O. Box 15035, Arlington, VA, 22215, US

(21) Appl. No.: 09/899,019

(22) Filed: Jul. 6, 2001

Related U.S. Application Data
(60) Provisional application No. 60/222,674, filed on Aug. 3, 2000.

(51) Int. Cl. A01K 77/00

(52) U.S. Cl. 43/11

(57) ABSTRACT

A multipurpose fishing net for sport anglers serves as a landing net, a “strip box” for holding line stripped from a reel prior to casting, and also as a shallow container for temporarily holding a freshly caught fish for photography or other momentary capture before release. A rigid frame is formed of lightweight tubular components, such as polyvinyl chloride (PVC) pipe. The structure is buoyant, with additional flotation provided by closed cell foam. A net is secured to two opposite sides or more preferably to all four sides of the frame, around the floatation foam portions. The net has some slack therein so that it extends loosely between opposite sides, to allow a captured fish to reside mostly within the water when the present net is floating therein. A tether extends from the frame of the device, for temporary attachment to clothing or other article.

### CROSS-REFERENCE TO RELATED APPLICATION

This application claims the benefit of U.S. Provisional Patent Application Ser. No. 60/222,674, filed Aug. 3, 2000.

### BACKGROUND OF THE INVENTION

1. Field of the Invention

The present invention relates generally to devices used for capturing and holding fish and game in hunting and sport fishing activities, and more specifically to a multipurpose fishing net for assisting in the landing of fish, holding the fish at the surface of the water or removed from the water for photography or other purposes, holding line during line stripping, and other purposes as desired. The present net includes a tether attachable to the angler, dock, boat, etc., to preclude loss thereof.

2. Description of the Related Art

Sport fishing as a hobby or recreational activity has become ever more popular with many people having increasing leisure time. Pitting oneself against the elements in an outdoor setting and learning about the habits and needs of wild animals and fish is an endlessly fascinating activity, which in addition may provide additional fresh food for anglers so inclined to keep their catch.

As a result, a vast market has grown to provide anglers with a huge variety of equipment dedicated to the sport fishing hobby. Specialized rods, reels, creels and other containers, not to mention the practically infinite number of lures available, provide an overwhelming selection of equipment for the angler. Needless to say, the ownership and carriage of even a small fraction of all of the equipment available, would be an impossible task for the typical angler.

An example of such equipment variety may be found in the field of fishing nets, where a large number of capture nets, seines, baskets, bait containers, and other devices have been developed in the past. Generally speaking, these various devices are relatively specialized in their aims and objectives, e.g., conventional landing nets having a relatively stiff frame with an extension handle which supports a deep and loosely gathered wide mesh net. Such devices are incapable of securely holding a captured fish therein, but only serve to retrieve the hooked fish from the water before depositing the fish in a creel or other holder, or releasing the fish as desired.

Other devices particularly directed to the holding of a landed or captured fish have also been developed. Such devices respond to the fact that the captured fish is very likely still alive, and can easily escape from an open net. Accordingly, such devices nearly all include some form of closure, to preclude escape of the fish.

However, these various devices do not provide for the display of a fish once caught or captured, which is an important point for many sport anglers who release fish after the catch. In many instances, the angler may wish to photograph a particularly large or impressive specimen before releasing the fish. Also, fish which are below certain predetermined size or weight limits, must be released after catching. The present multipurpose fishing net responds to these various needs, by providing a relatively shallow net extended across a rigid frame. The present net may be used for landing a hooked fish, but more importantly provides for the momentary display of the fish in the relatively shallow net. The frame is buoyant, which in combination with the slack provided in the net, ensures that a captured fish will be at least partially bathed or covered in water while the buoyant frame is floating in the water. With the present net, the angler need handle the fish very little if at all, during the catching, landing, photographing, and releasing operation, thereby reducing trauma to the fish and greatly increasing its chances of survival after release.

The present net is also useful in the specialized field of fly fishing, where line may be stripped from the reel before casting. The present net provides a floating receptacle which remains close at hand, for containing the stripped line prior to the cast. Heretofore, the line merely floated downstream after stripping, with the displaced line and drag of the water flow interfering with the casting operation. The present net thus serves as a “strip box,” ensuring that the line remains close at hand for casting.

A discussion of the related art of which the present inventor is aware, and its differences and distinctions from the present invention, is provided below.

U.S. Pat. No. 1,839,210 issued on Jan. 5, 1932 to James R. Felts et al., titled “Tobacco Basket,” describes a rigid structure with the slats of the basket being formed of metal and riveted together. As the device is a basket for carrying tobacco on land, no need for flotation or buoyancy was anticipated. Moreover, the structure is much too large (and heavy, considering the metal construction) for use as a fishing net for sport anglers, with the Felts et al. basket measuring 42 by 42 inches.

U.S. Pat. No. 1,841,956 issued on Jan. 19, 1932 to Herbert L. Juergens, titled “Fish Net,” describes a capture net having a circular opening defined by a flexible, buoyant tube. The net portion is quite deep for the capture of a fish therein, and the opening includes a closure net with drawstring for securely holding a fish therein. Also, no tether means is provided by Juergens for securing the net to another article or person, to preclude its drifting away in the water. The Juergens net is not adapted to the short duration display of a captured fish for photography or other purposes, but rather for the permanent capture of the fish, as evidenced by the drawstring closure net at the top of the device. In contrast, the relatively shallow present net, with no closure means, allows a fish to be placed gently thereatop for a photograph, with the net being lowered gently into the water for release of the fish.

U.S. Pat. No. 2,661,116 issued on Dec. 1, 1953 to Glen E. Bombarger, titled “Collapsible Fish Box,” describes a bait box having a rigid structure. The sides are formed of relatively rigid metal screen, with the top and bottom formed of perforated sheet metal. The normally closed top precludes photography of a fish captured therein, and in any event, the Bombarger box is much too deep to hold a fish on its side therein, for a photograph. Also, Bombarger does not disclose any flotation means for his fish box.

U.S. Pat. No. 3,081,576 issued on Mar. 19, 1963 to Harry C. Collins, titled “Fish Holder,” describes a loosely assembled structure having four rigid expanded metal panels. The intent of the device is to hold a fish relatively immobile while the hook is removed after landing the fish, or perhaps for carrying a larger fish. The device is not a net, as the rigid panels are tightened or secured completely around the fish after the catch. Moreover, no buoyancy is provided with the Collins device, while the buoyant nature of the present net, with its single net panel, allows a fish to be displayed openly thereon at the surface of the water.

U.S. Pat. No. 3,919,803 issued on Nov. 18, 1975 to Jerry R. Manguso, titled “Buoyant Fish Basket,” describes a basket or net more closely resembling the net of the Juergens '956 U.S. Patent, than the present invention. The Manguso basket has a solid closure panel for the top, and is intended to hold fish therein for a relatively long period (e.g., perhaps a few hours) submerged in the water for later killing and cleaning. As such, no single ply of shallow net for the short term display of a fish, is provided.

U.S. Pat. No. 4,272,906 issued on Jun. 16, 1981 to Gary Liebling, titled “Closeable Fish Net,” describes a net with a rigid rectangular frame and relatively deep capture net depending therefrom, as opposed to the shallow net of the present invention. The Liebling net also has a rigid handle extending therefrom with a remote lever thereon, for selectively opening and closing a transparent panel over the mouth of the net. The transparent panel would still preclude good photography of a fish captured therein, as the depth of the net precludes holding the fish extended on its side for a proper photograph. Moreover, the rigid handle teaches away from the flexible tether of the present multipurpose net, but is required by Liebling due to the closure actuating lever.

U.S. Pat. No. 4,878,311 issued on Nov. 7, 1989 to David L. Cano, titled “Buoyant Fishing Container,” describes a device with a rigid rectangular frame and porous lower sheet and upper cover or closure, unlike the present net. The Cano device provides for carrying various articles for fishing, as in a creel or tackle box, and thus is equipped with additional features, such as rod holders, etc. The Cano device includes a cover to preclude loss of articles therefrom. This also precludes placement of a fish therein for photography, as the closure would cover the fish. Also, Cano describes the bottom sheet as being formed of “relatively rigid Nylon netting” (column 4, line 16), whereas the present net material is a flexible, loosely applied sheet. In addition, Cano places the buoyant material within the hard frame tubes, while the soft flotation foam is placed over the structure in the present net.

U.S. Pat. No. 4,890,413 issued on Jan. 2, 1990 to Daniel E. Nelson et al., titled “Floating Fish Container With Adjustable Length Means And Biased Opening Means,” describes a holding net more closely related to the net devices of the Juergens '956 and Manguso '803 U.S. Patents discussed further above, than to the present multipurpose fishing net invention. The Nelson et al. net has a circular buoyant top ring, from which a generally cylindrical net depends. A rigid bottom ring extends around the bottom edge of the net, and is closed by additional net. A net top closure with drawstring extends across the circular upper edge. A sinker or other weight extends from the bottom of the device, to pull it downwardly into the water. This, along with the top closure, teaches away from the present invention, with its single ply or sheet of shallow net material which is disposed at or just beneath the surface of the water, when the device is floating in the water.

U.S. Pat. No. 4,905,404 issued on Mar. 6, 1990 to Randall J. Pasion et al., titled “Floating Fish Basket,” describes a generally cylindrical bag having net sides, for use by divers and spear fishermen. The Pasion et al. basket is more closely related to the devices of the Juergens '956, Manguso '803, and Nelson et al. '413 U.S. Patents discussed further above, particularly the device of the Manguso disclosure, than to the present fishing net. As with Manguso, Pasion et al. include a solid upper closure for their basket, precluding the taking of photographs of a fish or the like contained within the basket. Moreover, the Pasion et al. device is much too deep to hold a fish on its side for photography.

U.S. Pat. No. 5,276,989 issued on Jan. 11, 1994 to Derek W. Lumb et al., titled “Fish Handling Net,” describes a device having a rigid triangular frame and relatively deep pocketed portion. The pocket may be formed of rigid, perforated sheets or net material. A long, rigid handle extends from one apex of the triangular frame. Lumb et al. recognize the importance of keeping a fish wet, preferably immersed, between catching and weighing, in order to avoid undue trauma to the fish if it is to be released. However, the Lumb et al. device is not suitable for holding a fish while a photograph is taken of the fish, as provided by the relatively shallow holding surface of the present multipurpose fishing net invention.

U.S. Pat. No. 5,822,908 issued on Oct. 20, 1998 to Anthony P. Blanchard, titled “Fish Netting Device,” describes a net more closely resembling the device of the Liebling '906 U.S. Patent than the present net invention. The Blanchard net has a rigid rectangular frame with an elongate handle extending therefrom, including a remote lever for manipulating a net closure across the frame. Blanchard does not disclose any form of flotation for his net, as opposed to the present buoyant net. In addition, the Blanchard net is much too deep to hold a fish therein on its side for photography, as provided by the relatively shallow single ply net of the present multipurpose fishing net invention.

U.S. Pat. No. D-254,503 issued on Mar. 18, 1980 to Lupe S. Belasquez, titled “Floating Fish Holder,” illustrates a design more closely resembling the net of the Juergens, Manguso, Nelson et al., and Pasion et al. U.S. patents discussed above, than the present invention. The Belasquez design comprises a deep net bag having a V-shaped cross section, supported by a circular ring or frame at its top. A secondary net is provided within the upper opening, apparently as a closure. The frame includes an inwardly extending shelf with a series of receptacles therein. The Belasquez net cannot be used to support a fish resting upon its side, as provided by the present net invention with its single ply of net extending across the frame.

U.S. Pat. No. D-323,698 issued on Feb. 4, 1992 to Daniel E. Nelson et al., titled “Floating Fish Container,” illustrates a design based upon the device of the '413 U.S. Utility Patent to the same inventors, discussed further above. The same points of distinction between that device and the present invention, are seen to apply here as well.

Finally, French Patent Publication No. 2,700,443 published on Jul. 22, 1994 to Lucien Derrey describes (according to the English abstract) a fisherman's keep net assembly having a folding rigid frame with a net bag secured thereto. The frame may be extended to serve as a camp stool or the like, with the net depending from the upper portion thereof. The net portion may be used to hold a fish in the water. No flotation is apparent, and the net of the device is much too deep for use in supporting a fish on its side.

None of the above inventions and patents, taken either singly or in combination, is seen to describe the instant invention as claimed.

### SUMMARY OF THE INVENTION

The present invention comprises a multipurpose fishing net for landing a fish and holding the fish gently on its side in the water while removing the hook and perhaps photographing the fish prior to release. The present net may also be used as a landing net and as a shallow tray or container for stripping line thereinto, as may be done prior to casting when fly fishing. The present multipurpose net essentially comprises a rigid frame having buoyant flotation material applied thereto, with a net portion extending across the frame and flotation material. The net portion is preferably relatively loose, but not so loose as to provide any significant pocket or pouch; the sag may be on the order of an inch or so at the center of the net. A tether is also provided, for securing the device to an angler's clothing or equipment, or to a boat, dock, etc., to prevent the device from drifting away.

When an angler catches a fish, the fish may be placed gently within the central area of the net, where the shallow net holds the fish on its side. Yet, the slight sag of the net allows the fish to settle at least partially into the water, where the water flow continually washes over the fish to maintain the fish in good condition and reduce trauma to the fish. As the fish is resting upon its side in the present net, the fish may be photographed prior to release if so desired.

Accordingly, it is a principal object of the invention to provide an improved multipurpose fishing net for use as a landing net, display net for holding a fish therein, and as a container for stripping line thereinto prior to casting, for sport anglers.

It is another object of the invention to provide an improved multipurpose fishing net comprising a rigid frame having a single ply of net material loosely extending thereacross.

It is a further object of the invention to provide an improved multipurpose fishing net having a frame which is rectangular and formed of a series of sections of hollow tubular material.

An additional object of the invention is to provide an improved multipurpose fishing net having a frame which includes buoyancy means therewith.

Still another object of the invention is to provide an improved multipurpose fishing net including tether means for securing the net to another article.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental perspective view of the present multipurpose fishing net, showing its use in the display of a freshly caught fish.

FIG. 2 is an exploded perspective view of the net of FIG. 1, showing its various components and their relationships.

FIG. 3 is a bottom perspective view of a second embodiment of the present fishing net showing various details thereof, some of which are applicable to the embodiment of FIGS. 1 and 2.

Similar reference characters denote corresponding features consistently throughout the attached drawings.

### DETAILED DESCRIPTION OF THE PREFERRED EMBODIMENTS

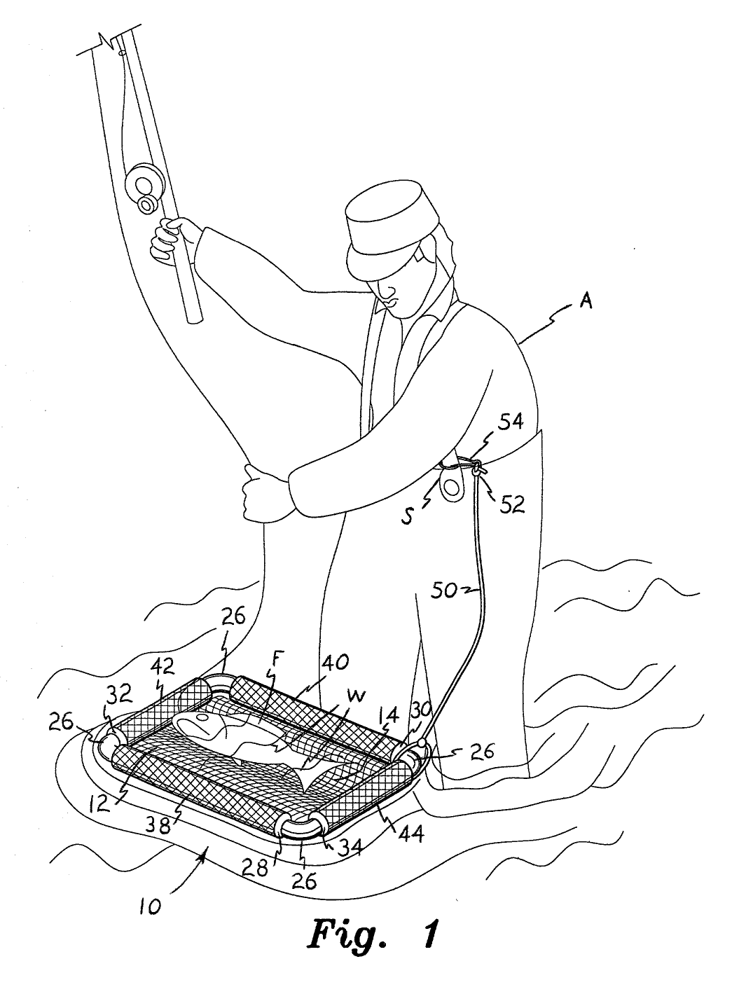

The present invention comprises a multipurpose fishing net, adapted for the landing of a fish and for brief and humane display of the fish after the catch for photography or other purposes prior to release of the fish, and for use as a “strip box” for placing line therein prior to a cast. FIG. 1 illustrates one use of the present net 10, wherein an angler A has just caught and landed a fish F and placed the fish F on the present net 10. The multipurpose net 10 is quite shallow, with the single ply of net material 12 having a certain amount of slack therein, as evidenced by the shallow pocket 14 formed therein by the weight of the fish F residing therein.

While the present net 10 is buoyant, the weight of the device, along with the slack in the net material 14, allows the fish F to settle into the water W flowing through the device, thereby keeping the fish F in a healthy state until release. This is an important characteristic of the present multipurpose net 10, as it allows an angler A to place a freshly caught fish F into the net 10 very briefly, removing the hook and photographing the fish F (if so desired) prior to release. It has been shown many times that the viability of a released fish is dependent upon such variables as the amount of handling the fish received and the amount of time the fish was out of water. The less the fish is handled, particularly while removed from the water, the better the condition of the fish will be after release and the more likely the fish will survive.

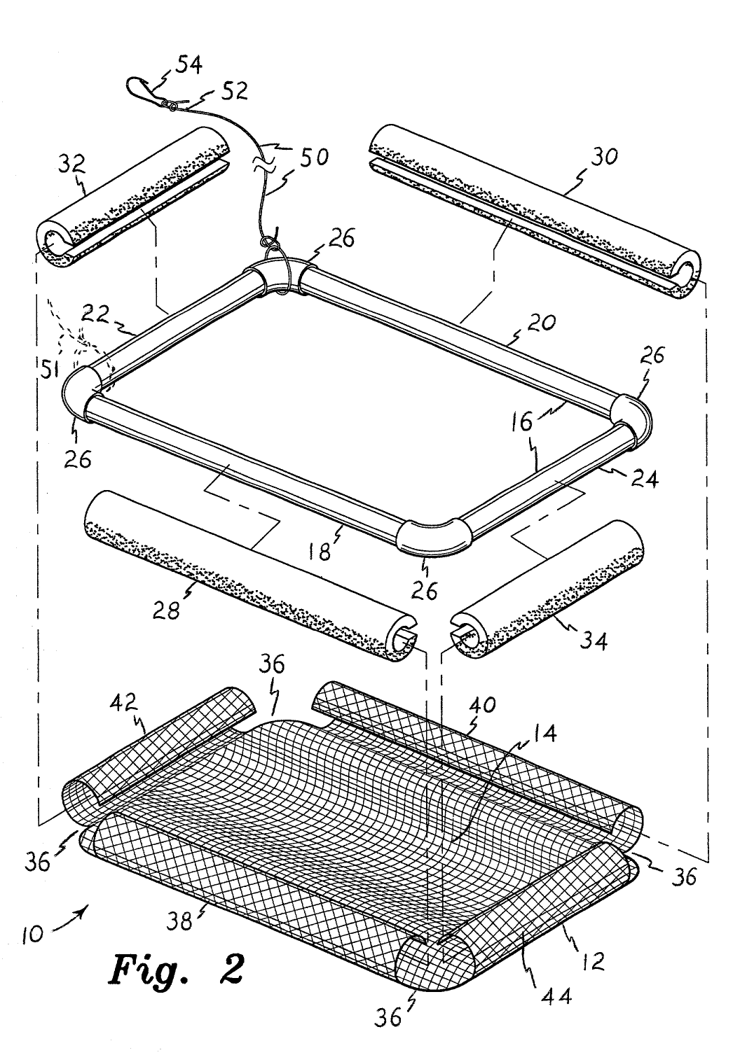

The present multipurpose net 10 provides for such brief and minimal handling of the fish F, by allowing the angler A to land the fish F by pushing the net 10 into the water beneath the fish F, once the fish has been played within reach. The shallowness of the net pocket 14 results in the fish F having insufficient depth to remain in a swimming position, yet results in approximately an inch or so of water W washing through the net 12 to keep the fish F substantially bathed in water to maintain the fish F in a healthy condition. As the fish F is not dehydrated to any appreciable extent during the landing and capturing process, it suffers no appreciable harm or trauma between capture and release. Yet, the shallowness of the present net 10 retains the fish F on its side briefly, while the angler photographs or measures the fish F as desired FIG. 2 provides a detailed illustration of the construction of the present multipurpose fishing net 10. The net material 12 is secured across a rigid frame 16, which is formed of a series of lengths of tubular material, such as polyvinyl chloride (PVC) plastic tube or pipe, or the like. Alternative materials may be used as desired, but the use of PVC pipe has been found to provide optimum properties of relatively good rigidity and relatively light weight for buoyancy. The frame 16 is preferably rectangular, with a first pair of opposed side members, respectively 18 and 20, and a second pair of opposed side members 22 and 24 orthogonally disposed to the first sides 18 and 20. The sides 18 through 24 are joined together by a like number of ninety degree elbows 26. While the rectangular configuration shown and described has been found to work well, it will be seen that other shapes may be constructed as desired while still adhering to the general concept of the present invention, i.e., providing a shallow draft net for briefly retaining a fish prior to its release after capture.

While the PVC or other frame members 18 through 24 preferably provide some buoyancy for the present net 10, additional flotation means may be added in the form of first through fourth sections of split cylindrical closed cell foam material, respectively 28 through 34. Such foam material is used for pipe insulation, and is provided in various internal diameters to fit closely about the selected size of PVC pipe which may be used to form the first through fourth sides 18 through 24 of the frame 16.

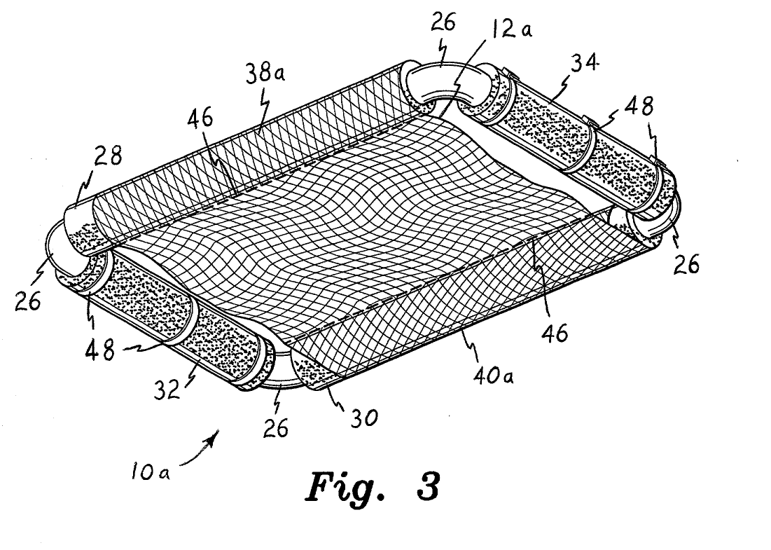

The net material 12 shown in FIGS. 1 and 2, includes a cutout 36 at each corner of the generally rectangular sheet. These cutouts 36 define a series of four extensions 38 through 44, which wrap respectively around the first through fourth sections of foam flotation material 28 through 34. The net extensions 38 through 44 may be secured around the foam flotation sections 28 through 34 by stitching 46, as shown in FIG. 3 of the drawings, or by means of plastic cable or wire ties 48, as shown securing the opposite third and fourth foam flotation sections 32 and 34 in FIG. 3. It will be seen that such cable ties 48 may be passed through the open weave of the net material 12 to secure the extensions 38 through 44 of the net material 12 to their respective foam flotation sections 28 through 34, simultaneously securing the foam sections 28 through 34 to their respective lengths of pipe 18 through 24 which comprise the sides of the frame 16. Other means of securing the assembly together may be used as desired (e.g., adhesives, etc.), but mechanical fastening (stitching, cable ties, etc.) is preferred due to the aquatic environment of the present invention and possible toxicity of any chemical adhesives to aquatic life.

FIG. 3 illustrates an alternative net 10a, wherein the net material 12a is secured only to two opposite side members of the frame 16, e. g., first and second side segments 18 and 20. More precisely, the opposite sides 38a and 40a of the net material 12a are secured about the two opposite flotation sections 28 and 30 which are in turn wrapped about the members 18 and 20 (not shown in FIG. 3, but identical to those components shown in FIG. 2).

Otherwise, the multipurpose net 10a of FIG. 3 is essentially identical to the net 10 of FIGS. 1 and 2, having a frame 16 formed of four straight lengths of material 18 through 24 connected by a like number of elbows 26. (While most of this frame is concealed in the FIG. 3 drawing, it will be understood that it is essentially identical to the frame 16 illustrated in FIG. 2.) The only difference between the multipurpose net embodiment 10a of FIG. 3 and the net embodiment of FIGS. 1 and 2, is the narrower width of the net material 12a, which does not extend around the two opposite frame end members 22 and 24 and their respective flotation members 32 and 34. Such a multipurpose net 10a is somewhat easier and more economical to construct, but the gap remaining at each end of the net material 12a may not be desirable for most users. It will be seen that a compromise net configuration (not shown) may also be constructed, wherein the net material has three extensions to secure about three of the four sides of the frame and its flotation members, if so desired.

Returning to FIG. 1, it will be appreciated that the present multipurpose net 10 (or 10a) may be used as an aid for virtually any type of sport fishing, but is particularly valuable for anglers who enjoy fly fishing in a moving body of water (trout stream, etc.). Such anglers often enjoy the sport of catching a nice fish, but then release the fish back to the water after the catch, perhaps after photographing the fish. In order to retain the present multipurpose net close at hand, some form of tether means is desirable to secure the net to some relatively stationary article.

FIGS. 1 and 2 illustrate the flexible tether line 50 which may be secured to some portion of the net 10, to preclude its drifting away from the angler. The tether 50 may be tied or otherwise secured to some portion of the net frame 16 (e.g., around one of the elbows 26, etc.), and has a distal end 52 terminating in a clip 54 or other suitable fastener. The clip 54 may be removably secured to some article or component of the angler's apparel or accessory being worn or carried on the person (e.g., to the strap or suspenders S of the waders being worn by the angler, as shown in FIG. 1), or perhaps secured to a part of the dock or boat structure when the angler is fishing from such locations. The tether 50 serves to retain the multipurpose net 10 or 10a conveniently at hand, for use as needed while fishing. A second tether, designated as tether 51 and shown partially in broken lines in FIG. 2 of the drawings, may be added to the multipurpose net 10 and/or any of its embodiments, if so desired. This secondary tether 51 may have an essentially identical configuration to the tether 50 and its clip 54, and serves to provide additional stability to the multipurpose net 10.

In summary, the present multipurpose net will be seen to fulfill several needs of the sport angler, particularly the fly fisherman who fishes in moving streams and the like. One such need is provision of a “strip box” for containing a quantity of fishing line removed (“stripped”) from the reel. In fly fishing, line is “stripped” from the reel in preparation for casting the relatively lightweight fly lure, with the angler feeding the line from the stripped length of line as the cast is made. The present multipurpose net in any of its embodiments, serves as a “strip box” to collect the stripped line, rather than allowing the line to drift downstream and perhaps become entangled in some object and ruining the cast.

After the cast is made, if a fish is caught, the angler must have some means of landing the fish. A fish supported only by the end of the fishing line may “slip the hook” during the struggle, particularly if the hook is not barbed (as may be the case where the angler plans to release the fish after the catch). In any event, a struggling fish suspended from the free end of a fishing line, is most difficult to grasp for hook removal and other purposes. Accordingly, the present multipurpose net may be used as a landing net when the fish is played within reach of the angler. The angler need only push one end of the net downwardly into the water beneath the fish, and allow the buoyancy of the net to cause the net to rise beneath the fish and capture the fish therein, somewhat as shown in FIG. 1 of the drawings.

Once the fish has been captured within the net, the net rides low in the water, with some water flowing through the porous net material. As the net material extends relatively loosely across the frame, a shallow pocket or depression is formed in the center of the net, particularly if an object (e.g., fish) has been placed therein. Yet, the pocket or depression is sufficiently shallow to hold the fish on its side, thereby allowing the angler to photograph the fish if so desired. The fish may be released after hook removal, merely by depressing the net beneath the surface of the water to allow the fish to swim away, thus reducing handling and resulting injury and trauma to the fish to a minimal degree.

The present multipurpose net thus greatly reduces the handling of the fish, which tends to preserve the health of the fish and its likely viability after release. It is well known that most species of fish develop a somewhat slippery protective coating, and the removal of this coating, as by handling the fish, can leave the fish susceptible to various diseases or invasive organisms which may attack the fish through the skin. Minimizing the handling of the fish by means of the present multipurpose net, greatly increases the chances of survival for a fish caught and released using the present net. Accordingly, the present multipurpose net will prove to be a valuable addition to the accessories of many sport anglers who are concerned about the environment and who are active participants in “catch and release” programs in their fishing, as well as others who wish to provide a more humane means of handling a fish after the catch.

It is to be understood that the present invention is not limited to the embodiments described above, but encompasses any and all embodiments within the scope of the following claims.

We claim:

1. A multipurpose fishing net, comprising:
a rigid frame;
a flotation device affixed to said frame; and
a single ply of flexible net material extending loosely across said frame and defining a shallow net pocket.

2. The multipurpose fishing net according to claim 1, wherein said frame is rectangular with a first pair of sides comprising opposed first and second sides and a second pair of sides comprising opposed third and fourth sides.

3. The multipurpose fishing net according to claim 2, wherein:
said frame is formed of first through fourth lengths of hollow tubular material; and
said lengths are joined to one another by four ninety degree elbows.

4. The multipurpose fishing net according to claim 2, wherein:
said flotation device comprises first through fourth sections of cylindrical closed cell foam material respectively secured over said first through fourth sides of said frame.

5. The multipurpose fishing net according to claim 2, wherein said net material is secured to each of said first through fourth sides of said frame.

6. The multipurpose fishing net according to claim 2, wherein said net material is secured to only one said pair of sides of said frame.

7. The multipurpose fishing net according to claim 1, further including flexible tether means secured to and extending from said frame.

8. A multipurpose fishing net, comprising:
a rigid frame;
a flotation device affixed to said frame;
a single ply of flexible net material extending loosely across said frame and defining a shallow net pocket; and
flexible tether means secured to and extending from said frame for tethering the multipurpose fishing net.

9. The multipurpose fishing net according to claim 8, wherein said frame is rectangular with a first pair of sections comprising opposed first and second sides and a second pair of sections comprising opposed third and fourth sides.

10. The multipurpose fishing net according to claim 9, wherein:
said frame is formed of first through fourth lengths of hollow tubular material; and
said lengths are joined to one another by four ninety degree elbows.

11. The multipurpose fishing net according to claim 9, wherein:
said flotation device comprises first through fourth sections of cylindrical closed cell foam material respectively secured over said first through fourth sides of said frame.

12. The multipurpose fishing net according to claim 9, wherein said net material is secured to each of said first through fourth sides of said frame.

13. The multipurpose fishing net according to claim 9, wherein said net material is secured to only one said pair of sides of said frame.

14. A multipurpose fishing net, comprising:
a rigid rectangular frame, having a first pair of sides comprising opposed first and second sides and a second pair of sides comprising opposed third and fourth sides;
a flotation device affixed to said frame; and
a single ply of flexible net material extending loosely across said frame and defining a shallow net pocket.

15. The multipurpose fishing net according to claim 14, wherein:
said frame is formed of first through fourth lengths of hollow tubular material; and
said lengths are joined to one another by four ninety degree elbows.

16. The multipurpose fishing net according to claim 14, wherein said flotation device comprises first through fourth sections of cylindrical closed cell foam material respectively secured over said first through fourth sides of said frame.

17. The multipurpose fishing net according to claim 14, wherein said net material is secured to each of said first through fourth sides of said frame.

18. The multipurpose fishing net according to claim 14, wherein said net material is secured to only one said pair of sides of said frame.

19. The multipurpose fishing net according to claim 14, further including flexible tether means secured to and extending from said frame for tethering the multipurpose fishing net.
